(19) United States
(12) Patent Application Publication
(10) Pub. No.: US 2002/0169033 A1
(43) Pub. Date: Nov. 14, 2002

(54) Method of making an article having a high moment of inertia and the article thus produced

(76) Inventor: Joseph Sery, San Diego, CA (US)

Correspondence Address: Kegler, Brown, Hill & Ritter, LPA, Suite 1800, 65 East State Street, Columbus, OH, 43215, US

(21) Appl. No.: 10/176,876

(22) Filed: Jun. 22, 2002

Related U.S. Application Data
(62) Division of application No. 09/717,732, filed on Nov. 21, 2000.

(51) Int. Cl. A63B 53/04; B29C 41/04

(52) U.S. Cl. 473/324; 264/255; 264/310; 264/311; 473/349

(57) ABSTRACT

A method of making an article having a high moment of inertia and the article thus produced which method involves rotating a mold around a central axis, inserting higher density materials into said mold which will be centrifugally forced to the opposite ends of the mold. Then inserting a liquid which is less dense and which will fill the mold and after having infiltrated and attached to the first material that has been placed therein, will harden into solid form.

### BACKGROUND OF THE INVENTION

While this invention is described with respect to a golf club head, particularly a polar balanced golf club head, it is to be understood that the invention is equally applicable to other products having a high moment of inertia. At the present time, polar balanced golf club heads, especially putters, are currently made by placing pre-formed heavy components in a stationary mold and then the body material is inserted into the mold by pouring or injecting under pressure. After the article has hardened it is removed from the mold. The pre-formed heavy components are costly and the retention of the heavy components is difficult. The strength is marginal and the finishing of the casting is costly.

### BRIEF SUMMARY OF THE INVENTION

The mold of the golf club head is provided with a centrally located opening and is attached to a mechanism to rotate it on a central axis as by attaching it to a rotating plate. The denser material, usually in the form of particulate matter such as spherical balls, may be inserted into the rotating mold through the central opening and centrifugal force causes these particles to be propelled to the ends of the golf club head mold. The particulate matter may also be placed in the mold prior to starting rotation of the mold. In doing this a removable partition such as paper or wire can be placed between the denser particulate matter prior to rotation and then removed as soon as rotation starts. This will ensure that the quantity which will concentrate at each end of the mold will be equal. If desired, the heavy particles can be guided into position by use of an electromagnetic field.

Thereafter, a lighter metal may be inserted into the rotating mold in liquid form and this metal fills the mold and infiltrates the denser particles but permits them to remain at each end of the mold. In place of a liquid metal, an appropriate plastic material in liquid form which can later be cured such as an epoxy can be inserted.

Alternatively, the denser particulate matter may be mixed with a small portion of the lighter metal or the plastic material and inserted into the rotating mold through the central opening and centrifugal force will cause this combination of materials to be propelled to the ends of the golf club head. Thereafter, a lighter metal or appropriate plastic material may be inserted into the mold to fill it.

The mold may contain a portion for the hosel and when the lighter metal is added to the center of the mold, it will also fill the portion of the mold which becomes the hosel.

After the combination of materials hardens, the product may be removed from the mold and attached to a shaft.

By using this method articles are produced which are lower in cost. There is a greater versatility of shapes and the finishing costs are reduced significantly.

It is therefore an object of this invention to provide a method of making an article having a high moment of inertia as well as the article thus produced.

It is a further object of this invention to make polar balanced golf club heads by utilizing this method.

This, together with other objects of the invention, will become apparent from the following detailed description of the invention and the accompanying drawings.

### BRIEF DESCRIPTION OF THE DRAWINGS

FIG. 1 is a perspective view of a mold showing the denser particulate material in phantom in each end of the mold.

FIG. 2. is a perspective view of a mold showing how the mold is rotated and the lighter metallic constituent of the golf club head is inserted into the mold.

FIG. 3 is sectional view of the mold shown in FIG. 1 on the section lines 3-3.

FIG. 4 is a section of FIG. 3 on the section lines 4-4.

FIG. 5 is a section of FIG. 3 on the section lines 5-5.

FIG. 6 is a section of FIG. 3 on the section lines 6-6.

### DETAILED DESCRIPTION OF THE INVENTION

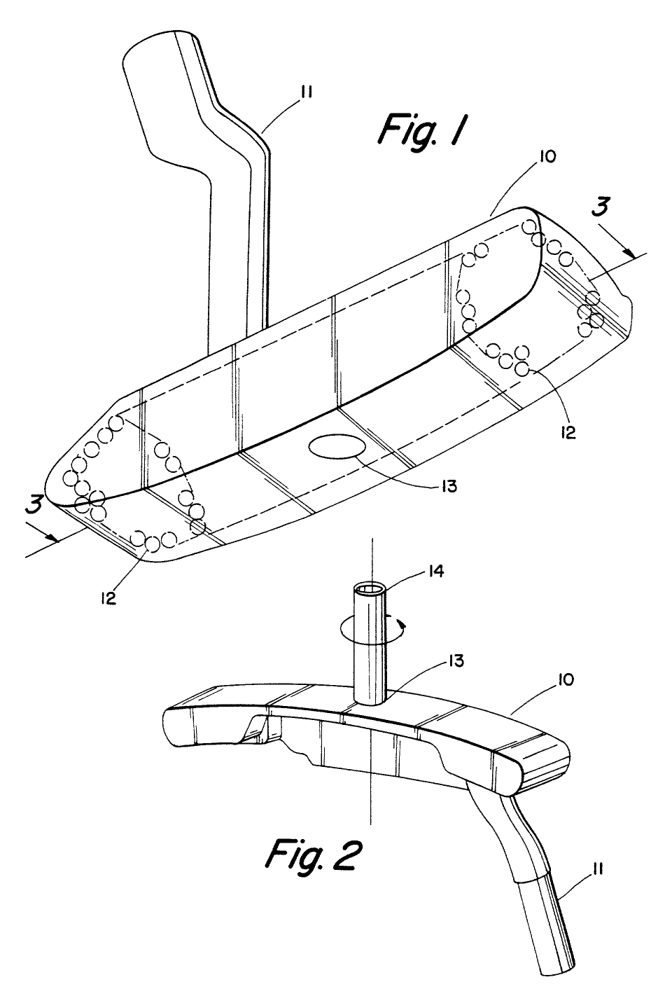

Referring now to FIG. 1, the mold 10 for the club head is shown with the hosel 11 and also shown are the denser spherical particles 12-12 which have been centrifugally forced to opposite ends of the club head. The opening 13 is designed as shown in FIG. 2 to hold a tubular member 14 which is located in the center of rotation of the golf club head so that the lighter metallic material in liquid form may be inserted therein. Once the materials have hardened, the mold is opened and the finished golf club head is removed.

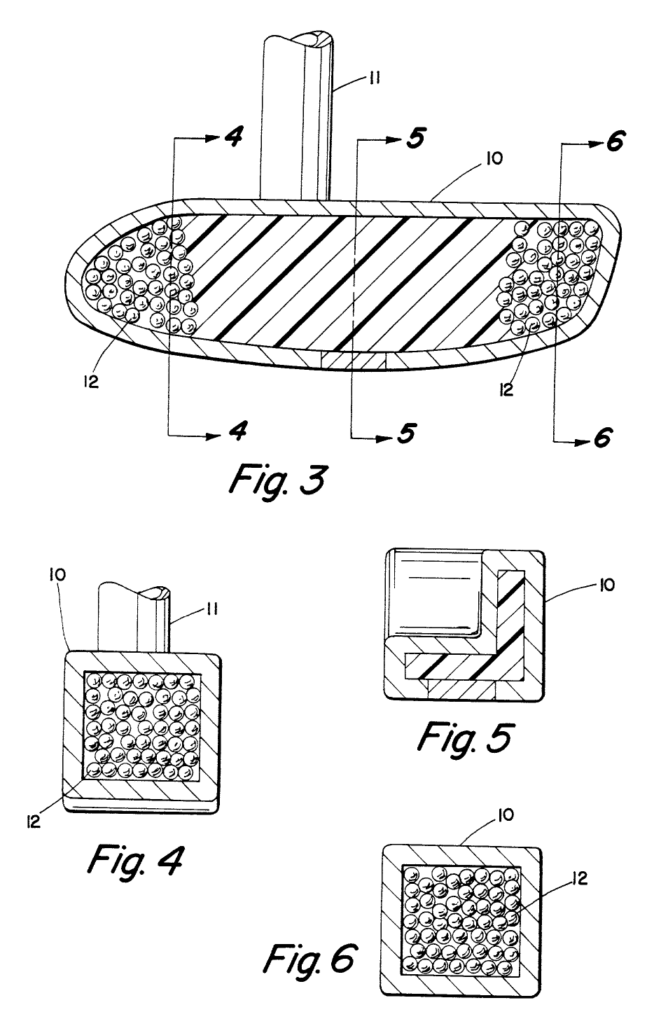

Referring now to FIGS. 3-6, the spherical particles 12-12, while shown at opposite ends of the mold in FIG. 3, are shown in section in FIG. 4 and FIG. 6. FIG. 5 shows the section through the mold of the portion of the golf club head which does not contain particles 12-12.

While this invention has been shown and described with respect to a golf club head, it should be understood by those skilled in the art that other products having a high moment of inertia may be formed in this fashion.

While this invention has been shown and described with respect to a detailed embodiment thereof, it will be understood by those skilled in the art that various changes in form and detail thereof may be made without departing from the scope of the claims of the invention.

What is claimed is:

1. A method of making an article having a high moment of inertia comprising:
inserting a first material in particulate form into a mold for said article, which material is denser than a second material which is to be later inserted into said center section of said mold,
rotating said mold on said article on said mold's central axis,
after the particles of said first material have been propelled to the extremities of said mold by centrifugal force, inserting a sufficient amount of a second hardenable material into the center of said mold to fill said mold and permitting said second material to infiltrate and attach to said first material and harden in said mold,
stopping the rotation of said mold,
removing said thus formed article combining said first material and said second material from said mold.

2. The method of claim 1 wherein said first material is mixed with a quantity of said second material when inserted into said mold.

3 The method of claim 1 wherein said article is a polar balanced golf club head.

4. The method of claim 2 wherein said article is a polar balanced golf club head.

5. The method of claim 3 wherein said first material comprises metallic pellets.

6. The method of claim 4 wherein said first material comprises metallic pellets.

7. The method of claim 5 wherein said second material is a liquid metal when inserted into the center of said mold.

8. The method of claim 6 wherein said second material is a liquid metal when inserted into the center of said mold.

9. The method of claim 5 wherein said second material is a curable plastic material in liquid form when inserted into the center of said mold.

10. The method of claim 6 wherein said second material is a curable plastic material in liquid form when inserted into the center of said mold.

11. The method of claim 7 wherein said article is a golf putter.

12. The method of claim 8 wherein said article is a golf putter.

13. The method of claim 9 wherein said article is a golf putter.

14. The method of claim 10 wherein said article is a golf putter.

15. An article having a high moment of inertia and having one dimension longer than any other dimension with the opposite ends of said longer dimension being denser than the remainder of said product and having been made by inserting a first material in particulate form into a mold, which material is denser than a second material which is to be later inserted into said center section of said mold,
rotating said mold for said article on said mold's central axis,
after the particles of said first material have been propelled to the extremities of said mold by centrifugal force, inserting a sufficient amount of a second hardenable material into the center of said mold to fill said mold and permitting said second material to infiltrate and attach to said first material and harden in said mold,
stopping the rotation of said mold,
removing said thus formed article combining said first material and said second material from said mold.

16. The article of claim 15 wherein said first material is mixed with a quantity of said second material when inserted into said mold.

17. The article of claim 15 wherein said article is a polar balanced golf club head.

18. The article of claim 16 wherein said article is a polar balanced golf club head.

19. The article of claim 17 wherein said first material comprises metallic pellets.

20. The article of claim 18 wherein said first material comprises metallic pellets.

21. The article of claim 19 wherein said second material is a liquid metal when inserted into said center of said mold.

22. The article of claim 20 wherein said second material is a liquid metal when inserted into said center of said mold.

23. The article of claim 19 wherein said second material is a curable plastic material in liquid form when inserted into the center of said mold.

24. The article of claim 20 wherein said second material is a curable plastic material in liquid form when inserted into the center of said mold.

25. The article of claim 21 wherein said article is a putter.

26. The article of claim 22 wherein said article is a putter.

27. The article of claim 23 wherein said article is a putter.

28. The article of claim 24 wherein said article is a putter.
